(19) United States
(12) Patent Application Publication
(10) Pub. No.: US 2024/0080364 A1
(43) Pub. Date: Mar. 7, 2024

(54) CONTROL DEVICE, CONTROL METHOD, AND RECORDING MEDIUM

(71) Applicant: NEC Corporation, Tokyo (JP)

(72) Inventor: Nozomu Takama, Tokyo (JP)

(73) Assignee: NEC Corporation, Tokyo (JP)

(21) Appl. No.: 18/238,225

(22) Filed: Aug. 25, 2023

(30) Foreign Application Priority Data
Sep. 2, 2022 (JP) 2022-139928

(51) Int. Cl. H04L 67/125; H04L 67/564

(52) U.S. Cl. CPC H04L 67/125; H04L 67/564

(57) ABSTRACT

A control device is connected to a base station, and a reception device that is installed in a usage range being a range in which the base station can be used, and receives a user device signal being transmitted from a user device and including a device ID being an ID of the user device. The control device includes: an acquisition unit that acquires, as a reception ID, the device ID included in the user device signal being received by the reception device in a case where the user device signal is received by the reception device; and a control unit that controls a function associated in advance with the reception ID among functions of the base station.

This application is based upon and claims the benefit of priority from Japanese Patent Application No. 2022-139928, filed on Sep. 2, 2022, the disclosure of which is incorporated herein in its entirety by reference.

### TECHNICAL FIELD

The present invention relates to a control device and the like.

### BACKGROUND ART

In recent years, a virtualized base station has been developed in wireless communication. The virtualized base station can increase and reduce a hardware resource of software to be used in the base station. For example, the virtualized base station learns a change in number of terminals connected to the base station. Then, when it is estimated that the number of terminals connected to the base station is small, the base station can achieve power conservation by reducing a hardware resource to be used.

Further, as a related art, there are techniques described in PTL 1 (Japanese Unexamined Patent Application Publication No. 2005-139789) and PTL 2 (Japanese Unexamined Patent Application Publication No. 2003-090155).

However, in a base station of local 5th generation (5G), an absolute number of terminals connected to the base station is often significantly smaller than the number of base stations of a public wireless communication service. Thus, a mechanism for performing power-conservation control by the number of terminals connected to a base station has lower effectiveness in the base station of the local 5G.

Further, there is a possibility of unauthorized access to a base station from a terminal without having usage qualification while the base station is activated. Thus, it is undesirable to provide an unnecessary service of a base station in terms of security. Further, it is also undesirable to provide an unnecessary service of a base station in terms of power conservation.

Meanwhile, a service usable by a user may vary by a user. For example, usage qualification given to a user may be only for a specific service among services provided by a base station, only for a service provided by a specific base station among a plurality of base stations, and the like. In such a manner, whether a service provided by a base station is necessary may depend on usage qualification of a user.

Thus, when a service provided by a base station is changed in terms of power conservation, security, and the like, it is desirable to change the service provided by the base station according to a user.

### SUMMARY

An object of the present invention is, in view of the problem described above, to provide a control device and the like that are able to change a service provided by a base station according to a user.

In one aspect of the present invention, a control device connected to a base station, and a reception device that is installed in a usage range being a range in which the base station can be used, and receives a user device signal being transmitted from a user device and including a device ID being an ID of the user device is the control device including: an acquisition unit that acquires, as a reception ID, the device ID included in the user device signal being received by the reception device in a case where the user device signal is received by the reception device; and a control unit that controls a function associated in advance with the reception ID among functions of the base station.

Further, in another aspect of the present invention, a control method of a control device connected to a base station, and a reception device that is installed in a usage range being a range in which the base station can be used, and receives a user device signal being transmitted from a user device and including a device ID being an ID of the user device is the control method including: acquiring, as a reception ID, the device ID included in the user device signal being received by the reception device in a case where the user device signal is received by the reception device; and controlling a function associated in advance with the reception ID among functions of the base station.

Further, in another aspect of the present invention, a computer program recorded in a non-transitory computer-readable recording medium recording a control program of a control device connected to a base station, and a reception device that is installed in a usage range being a range in which the base station can be used, and receives a user device signal being transmitted from a user device and including a device ID being an ID of the user device is the control program causing a computer to achieve: an acquisition function of acquiring, as a reception ID, the device ID included in the user device signal being received by the reception device in a case where the user device signal is received by the reception device; and a control function of controlling a function associated in advance with the reception ID among functions of the base station.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of a control device according to a first example embodiment of the present invention;

FIG. 2 is a diagram illustrating an example of an operation flow of the control device according to the first example embodiment of the present invention;

FIG. 3 is a diagram illustrating a configuration example of a system including a control device according to a second example embodiment of the present invention;

FIG. 4 is a diagram illustrating a configuration example of a reception device according to the second example embodiment of the present invention;

FIG. 5 is a diagram illustrating a configuration example of the control device according to the second example embodiment of the present invention;

FIG. 6 is a diagram illustrating another configuration example of the system including the control device according to the second example embodiment of the present invention;

FIG. 7 is a diagram illustrating an example of an operation flow of the control device according to the second example embodiment of the present invention;

FIG. 8 is a diagram illustrating an example of an operation flow of the control device according to the second example embodiment of the present invention; and

FIG. 9 is a diagram illustrating a hardware configuration example of each of the example embodiments of the present invention.

### EXAMPLE EMBODIMENT

### First Example Embodiment

A first example embodiment of the present invention will be described. One specific example of a control device 10 in the first example embodiment is a control device 20 in a second example embodiment described below.

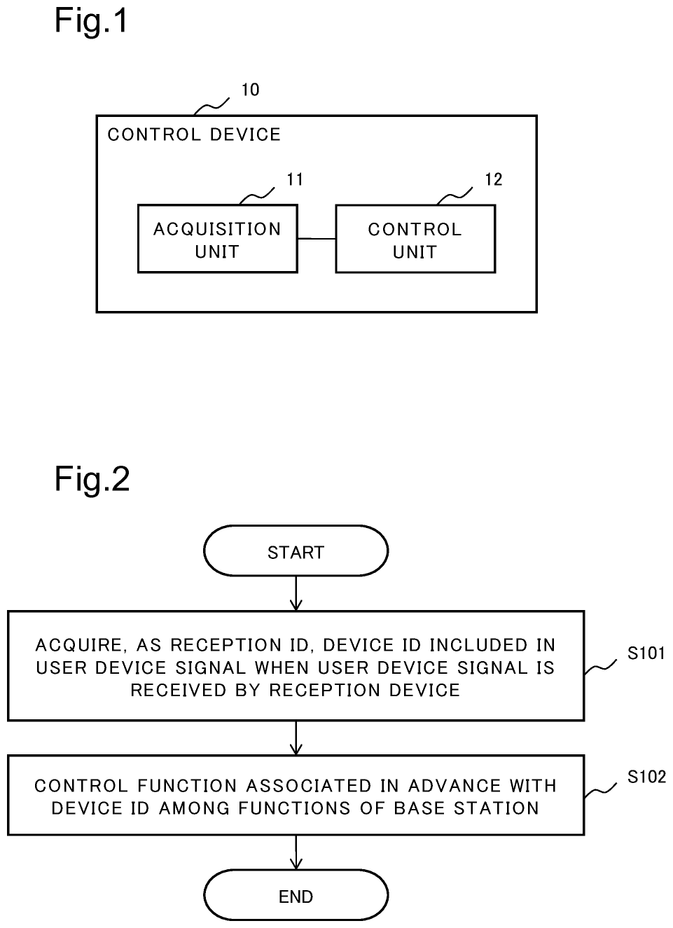

FIG. 1 illustrates a configuration example of the control device 10 according to the present example embodiment.

The control device 10 is connected to a reception device and a base station. The reception device is installed in a usage range of the base station. The usage range of the base station is a range in which the base station can be used. The reception device receives a user device signal that is transmitted from a user device and includes a device ID being identification (ID) of the user device.

The control device 10 includes an acquisition unit 11 and a control unit 12.

The acquisition unit 11 acquires, as a reception ID, the device ID included in the user device signal being received by the reception device in a case where the user device signal is received by the reception device.

The control unit 12 controls a function associated in advance with the reception ID among functions of the base station.

Next, FIG. 2 illustrates an example of an operation flow of the control device 10 according to the present example embodiment.

The acquisition unit 11 acquires, as a reception ID, a device ID being received by a reception device and included in a user device signal in a case where the user device signal is received by the reception device (step S101).

The control unit 12 controls a function associated in advance with the reception ID among functions of a base station (step S102).

As described above, in the first example embodiment of the present invention, the control device 10 includes the acquisition unit 11 and the control unit 12. The acquisition unit 11 acquires, as a reception ID, a device ID being received by a reception device and included in a user device signal in a case where the user device signal is received by the reception device. The control unit 12 controls a function associated in advance with the reception ID among functions of a base station.

In such a manner, the control device 10 controls, for a base station associated in advance with a device ID (reception ID) of a user device approaching a reception device, a function of the base station. In this way, the control device 10 controls a function of a base station according to a user device carried by a user, and thus a service provided by the controlled function changes. Thus, a service provided by a base station can be changed according to a user.

### Second Example Embodiment

Next, the second example embodiment of the present invention will be described. One specific example of the control device 10 in the first example embodiment is the control device 20 in the second example embodiment.

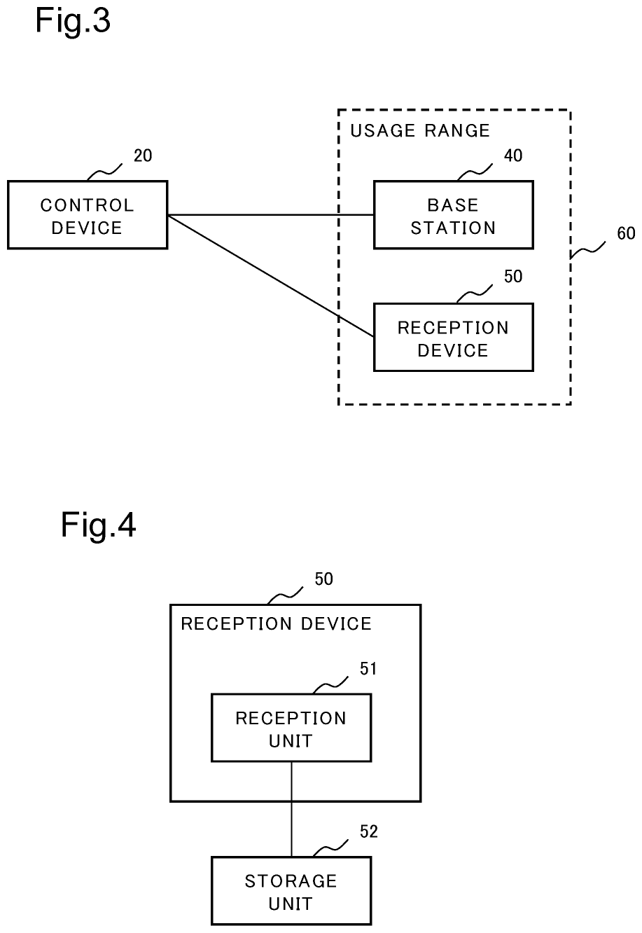

First, FIG. 3 illustrates a configuration example of a system including the control device 20 according to the present example embodiment. The system illustrated in FIG. 3 includes the control device 20, a base station 40, and a reception device 50.

The base station 40 is a base station of wireless communication, for example, a base station of local 5G. A place where the base station 40 is installed is, for example, a factory that operates in a daytime period, a construction site that operates at a specific time, a site at which wireless communication is desired to be used only during specific work, such as a place (a dam and the like) where there are usually no people, and the like.

The reception device 50 is installed in a usage range 60 of the base station 40. The usage range 60 is a range in which the base station 40 can be used. For example, in a case where the usage range 60 of the base station 40 is a factory, the reception device 50 is installed near an entrance of the factory, and the like.

Next, FIG. 4 illustrates a configuration example of the reception device 50 according to the present example embodiment. The reception device 50 includes a reception unit 51. The reception unit 51 is connected to a storage unit 52. The reception device 50 may include the storage unit 52.

The reception unit 51 of the reception device 50 receives a user device signal. The user device signal is a wireless signal that is transmitted from a user device and includes a device ID being an ID of the user device.

The user device is a device that transmits a user device signal. The user device is, for example, a Bluetooth (registered trademark) tag. For example, the user device may transmit a user device signal by Bluetooth low energy (BLE), or may transmit a user device signal by another method. The user device is distributed in advance to a user who can use a wireless communication service provided by the base station 40. The user device may be shared by a group of users having the same usage authority over the base station 40.

A user carries a user device (tag), uses a wireless terminal, and uses a wireless communication service provided by the base station 40. The wireless terminal is a terminal in which the wireless communication service provided by the base station 40 can be used. The wireless terminal is, for example, a smartphone, a tablet terminal, a personal computer, and the like.

The user device may have a function of the wireless terminal. In this case, a user carries the user device having the function of the wireless terminal. Further, in this case, a user device signal may be transmitted by a Bluetooth function of the wireless terminal.

The reception device 50 can detect that a user device approaches the base station 40 by receiving a user device signal. When the reception unit 51 of the reception device 50 receives the user device signal, the reception unit 51 stores, in the storage unit 52, a device ID included in the user device signal and reception time information being information about a time at which the user device signal is received in association with each other.

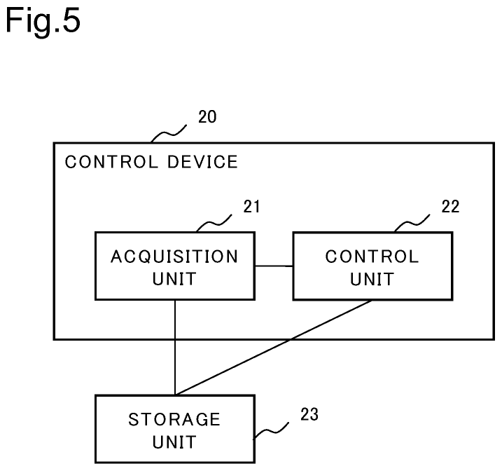

Next, FIG. 5 illustrates a configuration example of the control device 20 according to the present example embodiment. The control device 20 includes an acquisition unit 21 and a control unit 22. The acquisition unit 21 and the control unit 22 are connected to a storage unit 23. The storage unit 23 may be included in the control device 20.

The acquisition unit 21 acquires, as a reception ID, a device ID included in a user device signal being received by the reception device 50 in a case where the user device signal is received by the reception device 50. The reception ID is a device ID included in a user device signal received by the reception device 50. Further, the acquisition unit 21 adds the acquired reception ID to a reception ID list. The reception ID list is stored in the storage unit 23. The reception ID list is a list of device IDs of user devices present near the reception device 50 (in a range in which the reception device 50 can receive a user device signal).

For example, the acquisition unit 21 regularly checks a device ID stored in the storage unit 52 by the reception device 50. Then, in a case where a new device ID is stored in the storage unit 52, the device ID is acquired as a reception ID.

Further, for example, the acquisition unit 21 may receive, from the reception device 50, a notification about reception of a user device signal including a new device ID. The notification includes the device ID included in the user device signal received by the reception device 50. In this case, the acquisition unit 21 acquires, as a reception ID, the device ID notified in the notification. Further, in this case, in a case where the reception unit 51 of the reception device 50 receives a user device signal including a device ID that is not stored in the storage unit 52, the reception unit 51 transmits the notification to the control device 20. Further, in a case where the reception unit 51 of the reception device 50 receives a user device signal including a device ID stored in the storage unit 52, and reception time information stored in association with the device ID in the storage unit 52 indicates a time in the past by a predetermined period of time or longer, the reception unit 51 also transmits the notification.

The control unit 22 controls a function associated in advance with a reception ID among functions of the base station 40. A correspondence between a device ID and a function of the base station 40 is stored in advance in the storage unit 23.

For example, a function associated with a device ID may be a power function of the base station 40. In this case, a correspondence between the device ID and the function of the base station 40 may be a list of device IDs of user devices being usable by the base station 40.

Then, in this case, in a state where the power function of the base station 40 associated with a reception ID is off, the control unit 22 performs control for turning on the power function of the base station 40. In such a manner, in a case where a user device associated with the power function of the base station 40 approaches the reception device 50, the control unit 22 can turn on the power function of the base station 40.

Further, in a case where a user device associated with the power function of the base station 40 is not present near the reception device 50, the control unit 22 may turn off the power function of the base station 40. In this case, after a predetermined period of time has elapsed since the user device associated with the power function of the base station 40 is not present near the reception device 50, the control unit 22 may turn off the power function of the base station 40.

There is a possibility that a plurality of user devices are present near the reception device 50, and the base station 40 is used by a wireless terminal. Thus, in a case where there are a plurality of device IDs associated with the power function of the base station 40, in a case where none of a user device signal including the device ID associated with the power function of the base station 40 is received by the reception device 50, the control unit 22 performs control for turning off the power function of the base station 40. In such a manner, in a case where a user device associated with the power function of the base station 40 is not present near the reception device 50, the control unit 22 can turn off the power function of the base station 40. In this way, the control device 20 can achieve power conservation of the base station 40. Further, in a case where a user device associated with the power function of the base station 40 is not present near the reception device 50, a wireless terminal cannot use the base station 40, which is also preferable in terms of security.

Further, a function associated with a device ID may be a part or the whole of components of the base station 40. In this case, the base station 40 includes the plurality of components. Further, the components may be virtualized. In this case, a correspondence between a device ID and a function of the base station 40 may be information about the components of the base station 40 being usable by a user device indicated by the device ID. Each of the plurality of components is, for example, mobile edge computing (MEC), a virtual user plane function (vUPF), or a virtual radio access network (vRAN). The MEC achieves a service provided by the base station 40.

Then, in a case where there is a component that is not activated among components associated with a reception ID, the control unit 22 performs control for activating the component. For example, in a case where a component associated with a reception ID is a virtual machine, the control unit 22 notifies the base station 40 of identification information about the virtual machine, and instructs the base station 40 to activate the virtual machine. In such a manner, the control device 20 can activate a component associated with a user device approaching the reception device 50. When the base station 40 activates the component, a wireless terminal can use a service provided by the base station 40.

Further, in a case where none of a user device signal including a device ID associated with the component is received by the reception device 50, the control unit 22 performs control for stopping the component. In such a manner, in a case where a user device associated with the component is not present near the reception device 50, the control unit 20 can stop the component. In this way, the control device 20 can achieve power conservation of the base station 40. Further, in a case where a user device associated with the component of the base station 40 is not present near the reception device 50, a wireless terminal cannot use a service provided by the component, which is also preferable in terms of security.

Further, the MEC stores, for example, a list (white list) of pieces of identification information about wireless terminals that can use the MEC, and, in a case of access from a wireless terminal whose identification information is not stored in the white list, the access from the wireless terminal may be rejected. In such a manner, the MEC is activated by a user device (tag) approaching a reception device, and the MEC performs access control of the wireless terminal.

Further, a function associated with a device ID may be a part or the whole of a plurality of network slices. In this case, the base station 40 includes the plurality of components. The components may be virtualized. In this case, a correspondence between a device ID and a function of the base station 40 may be identification information about a network slice being usable by a user device indicated by the device ID. The identification information about a network slice may be, for example, single-network slice selection assistance information (S-NSSAI). Note that the storage unit 23 stores, in advance, a correspondence between the identification information about a network slice and a component needed for the network slice. Each of the plurality of components is, for example, a vUPF or a vRAN.

Then, in a case where there is a network slice that is not formed among network slices associated with reception IDs, the control unit 22 performs control for forming the network slice. Specifically, the control unit 22 notifies the base station 40 of identification information about a network slice associated with a reception ID and identification information about a component (for example, a virtual machine) associated with the network slice. Then, the base station 40 forms the network slice indicated by the notified identification information in the component indicated by the notified identification information. In such a manner, the control device 20 can form a network slice used by a user device approaching the reception device 50.

When a network slice is formed, a wireless terminal can achieve wireless communication by the network slice. Note that identification information about a usable network slice is stored in advance in a wireless terminal.

Further, in a case where none of a user device signal including a device ID associated with a network slice is received by the reception device 50, the control unit 22 performs control for setting the network slice in a non-formation state. In such a manner, in a case where a user device associated with a network slice is not present near the reception device 50, the control unit 20 can set the network slice in a non-formation state.

Note that, for example, the control device 20 can detect as follows that a user device moves away from the reception device 50.

For example, the acquisition unit 21 checks reception time information associated with a device ID present in a reception ID list stored in the storage unit 23 among device IDs stored in the storage unit 52 by the reception device 50. Then, in a case where the reception time information associated with the device ID indicates the past by a predetermined period of time or longer, the acquisition unit 21 can recognize that a user device of the device ID moves away from the reception device 50. Then, the acquisition unit 21 deletes the device ID from the reception ID list.

Further, for example, the acquisition unit 21 may receive, from the reception device 50, a notification that a user device moves away. The notification includes a device ID of the user device that moves away from the reception device 50. In this case, the reception unit 51 of the reception device 50 checks, at intervals of a predetermined period of time, reception time information stored in the storage unit 52. Then, in a case where there is reception time information indicating a time before a predetermined period of time or longer, the reception unit 51 transmits the notification indicating the device ID associated with the reception time information.

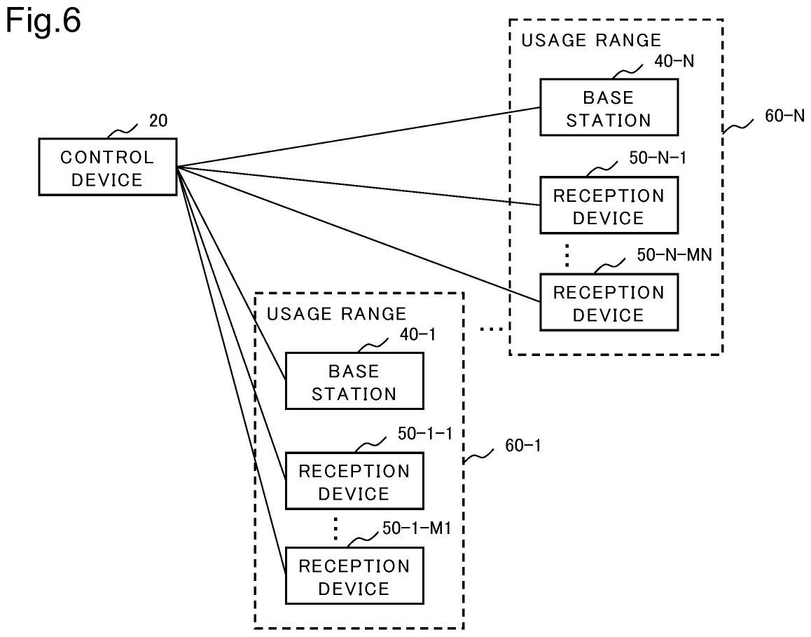

Next, FIG. 6 illustrates another configuration example of the system including the control device 20 according to the present example embodiment. The system illustrated in FIG. 6 includes the control device 20, a base station 40-i (i is an integer from 1 to N), and a reception device 50-i-j (j is an integer from 1 to Mi). The control device 20 is connected to each base station 40-i. Further, the control device 20 is connected to each reception device 50-i-j. The reception device 50-i-j is included in a usage range 60-i of the base station 40-i. Mi reception devices are included in the usage range 60-i of the base station 40-i. In this way, the number of the base stations 40-i connected to the control device 20 may be one, or two or more. Further, the number of the reception device 50-i-j included in the usage range 60-i of the base station 40-i may be one, or two or more.

When the plurality of base stations 40-i are connected to the control device 20, the storage unit 23 stores, in advance, information about the reception device 50-i-j included in the usage range 60-i of each of the base stations 40-i, i.e., a correspondence between the base station 40-i and the reception device 50-i-j. Further, in this case, the storage unit 23 stores, in advance, a correspondence between a device ID and a function of the base station. Note that one, or two or more base stations can be associated with a device ID.

Then, the control unit 22 controls a function of the base station 40-i. In this case, the base station 40-i having the function controlled by the control unit 22 is included in a base station associated with a reception ID. Further, the reception device 50-i-j that has received a user device signal including a reception ID is associated with the base station 40-i having the function controlled by the control unit 22. In other words, in a case where a user device approaches the reception device 50-i-j, the control unit 22 controls the function of the base station 40-i associated with the reception device 50-i-j among the base stations associated with the user device.

Further, a base station having a function controlled by the control unit 22 may be a base station associated with a reception ID. In this case, in a case where a user device approaches any of the reception devices 50-i-j, the control unit 22 controls a function of the base station associated with the user device. In this case, in a case where a user device approaches any of the reception devices, the control unit 22 controls a function of the base station associated with the user device regardless of which reception device has received a user device signal. For example, in a case where a specific user device approaches any of the reception devices, the control device 20 performs control for activating a function of a base station approached by the user device, and a specific function of a remote base station associated with the user device. Then, a usage scene where a wireless terminal acquires information from a device connected to the remote base station via a close base station and the remote base station is conceivable.

Note that, in a case of the example illustrated in FIG. 6, one base station 40-i is included in one usage range 60-i. However, two or more base stations may be included in one usage range 60-i. In this case, in a correspondence between a reception device and a base station, one reception device may be associated with one, or two or more base stations. Note that the correspondence between the reception device and the base station is stored in the storage unit 23.

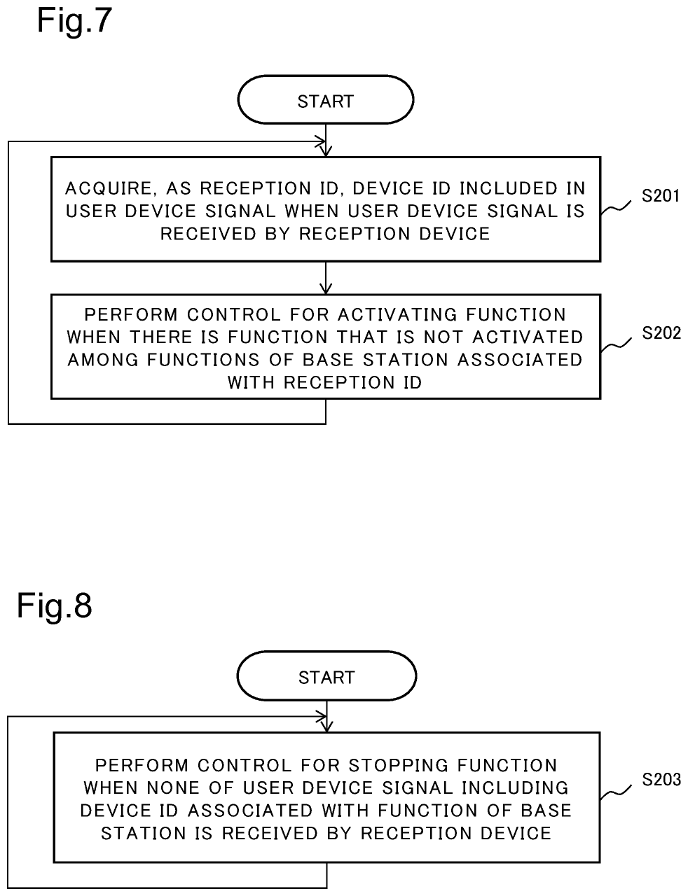

Next, FIGS. 7 and 8 illustrate an example of an operation flow of the control device 20 according to the present example embodiment.

The acquisition unit 21 of the control device 20 acquires, as a reception ID, a device ID being received by a reception device and included in a user device signal in a case where the user device signal is received by the reception device (step S201 in FIG. 7).

The control unit 22 controls a function associated in advance with the reception ID among functions of a base station. Specifically, in a case where there is a function that is not activated among functions of a base station associated with the reception ID, the control unit 22 performs control for activating the function (step S202). At this time, the control unit 22 may control a function of a base station associated with the reception device that has received the user device signal including the reception ID among base stations associated with the reception ID.

More specifically, in step S202, in a case where a function associated with the reception ID is a power function of a base station, the control unit 22 performs control for turning on the power function of the base station in a state where the power function of the base station is off.

In a case where a function associated with the reception ID is a component of a base station, in a case where there is a component that is not activated among components associated with the reception ID, the control unit 22 performs control for activating the component.

In a case where a function associated with the reception ID is a network slice, in a case where the network slice associated with the reception ID is not formed, the control unit 22 performs control for forming the network slice.

Further, in a case where none of the user device signal including the device ID associated with the function of the base station is received by the reception device, the control unit 22 performs control for stopping the function (step S203 in FIG. 8).

In step S203, in a case where the function associated with the reception ID is the power function of the base station, the control for stopping the function is control for turning off the power function of the base station. When the function associated with the reception ID is the component of the base station, the control for stopping the function is control for stopping the component. When the function associated with the reception ID is the network slice, the control for stopping the function is control for setting a state where the network slice is not formed.

As described above, in the second example embodiment of the present invention, the control device 20 includes the acquisition unit 21 and the control unit 22. The acquisition unit 21 acquires, as a reception ID, a device ID being received by a reception device and included in a user device signal in a case where the user device signal is received by the reception device. The control unit 22 controls a function associated in advance with the reception ID among functions of a base station.

In such a manner, the control device 20 controls, for a base station associated in advance with a device ID (reception ID) of a user device approaching a reception device, a function of the base station. In this way, the control device 10 controls a function of a base station according to a user device carried by a user, and thus a service provided by the controlled function changes. Thus, a service provided by a base station can be changed according to a user.

Further, a function associated with a reception ID may be a power function of a base station. In this case, in a state where the power function of the base station is off, the control unit 22 performs control for turning on the power function of the base station. Thus, in a case where a user device that has qualification to use a base station approaches a reception device, the control device 20 can turn on the power function of the base station and provide a service.

Further, in a case where none of a user device signal including a device ID associated with the power function of the base station is received by the reception device, the control unit 22 performs control for turning off the power function of the base station. Thus, the control device 20 can achieve power conservation of the base station by turning off an unnecessary power function of the base station. Further, in a case where a user device associated with the power function of the base station is not present near the reception device 50, a wireless terminal cannot use the base station, and thus unauthorized access can be reduced.

Further, in a case where a base station includes a plurality of components, a function associated with a reception ID may be a part or the whole of the components of the base station. Each of the plurality of components of the base station may be, for example, MEC, a vUPF, or a vRAN. In this case, in a case where there is a component that is not activated among the components associated with the reception ID, the control unit 22 performs control for activating the component. Thus, in a case where a user device that has qualification to use a service provided by the component approaches a reception device, the control device 20 can activate the component, and provide a service by the component.

Further, in a case where none of a user device signal including a device ID associated with the component is received by the reception device, the control unit 22 performs control for stopping the component. Thus, the control device 20 can achieve power conservation of the base station by stopping an unnecessary function of the base station. Further, in a case where a user device associated with the component of the base station is not present near the reception device 50, a wireless terminal cannot use a service by the component, and thus unauthorized access can be reduced.

Further, a function associated with a reception ID may be a part or the whole of a plurality of network slices. In this case, in a case where the network slice associated with the reception ID is not formed, the control unit 22 performs control for forming the network slice. Thus, in a case where a user device that has qualification to use a service provided by the network slice approaches a reception device, the control device 20 can form the network slice, and provide a service by the network slice.

Further, in a case where none of a user device signal including a device ID associated with a network slice is received by the reception device, the control unit 22 performs control for setting a state where the network slice is not formed. Thus, in a case where a user device associated with a network slice is not present near the reception device 50, the control unit 20 can set the network slice in a non-formation state.

Further, in a case where a plurality of base stations are present, one or more base stations are associated with a reception ID. In this case, the control unit 22 may control a function of a base station associated with a reception device that has received a user device signal including the reception ID among the base stations associated with the reception ID. In such a manner, the function of the base station approached by the user device can be controlled, and a service by the base station approached by the user device can be provided to a user.

Further, in a case where a plurality of base stations are present, one or more base stations are associated with a reception ID. In this case, the control unit 22 may control a function of the base station associated with the reception ID. In such a manner, a service by a function of a base station different from a base station approached by a user device can be provided to a user depending on authority provided to the user device.

[Hardware Configuration Example]

A configuration example of a hardware source that achieves the control device (10, 20) according to each of the example embodiments of the present invention described above by using one information processing device (computer) will be described. Note that the control device may be achieved by physically or functionally using at least two information processing devices. Further, the control device may be achieved as a dedicated device. Further, only a part of a function of the control device may be achieved by using the information processing device.

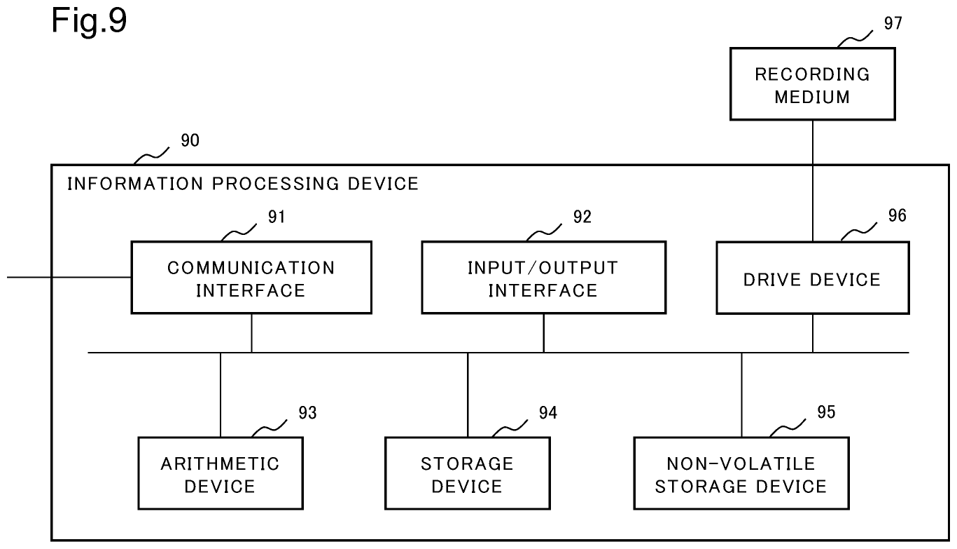

FIG. 9 is a diagram schematically illustrating a hardware configuration example of an information processing device that can achieve the control device according to each of the example embodiments of the present invention. An information processing device 90 includes a communication interface 91, an input/output interface 92, an arithmetic device 93, a storage device 94, a non-volatile storage device 95, and a drive device 96.

For example, the acquisition unit 11 and the control unit 12 in FIG. 1 can be achieved by the communication interface 91 and the arithmetic device 93.

The communication interface 91 is a communication means for allowing the control device according to each of the example embodiments to communicate with an external device in a wired and/or wireless manner. Note that, when the control device is achieved by using at least two information processing devices, the control device may be connected in such a way as to perform communication between the information processing devices with each other via the communication interface 91.

The input/output interface 92 is a man-machine interface, such as a keyboard being one example of an input device and a display as an output device.

The arithmetic device 93 is an arithmetic processing device, such as a general-purpose central processing unit (CPU) and a microprocessor, and a plurality of electric circuits. For example, the arithmetic device 93 can read, in the storage device 94, various types of programs stored in the non-volatile storage device 95, and execute processing according to the read program.

The storage device 94 is a memory device, such as a random access memory (RAM), that can be referred from the arithmetic device 93, and stores a program, various types of data, and the like. The storage device 94 may be a volatile memory device.

The non-volatile storage device 95 is a non-volatile storage device such as a read only memory (ROM) and a flash memory, for example, and can store various types of programs, data, and the like.

For example, the drive device 96 is a device that processes reading and writing of data from and to a recording medium 97 described below.

The recording medium 97 is any recording medium that can record data, such as an optical disk, a magneto-optical disk, and a semiconductor flash memory, for example.

According to each of the example embodiments of the present invention, for example, the control device is constituted of the information processing device 90 illustrated in FIG. 9, and the control device may be achieved by supplying, to the control device, a program that can achieve a function described in each of the above-described example embodiments.

In this case, the example embodiment can be achieved by the arithmetic device 93 executing the program supplied to the control device. Further, a part of a function instead of the entire control device can also be constituted of the information processing device 90.

Furthermore, the above-described program may be recorded in the recording medium 97, and the control device may be constituted in such a way that the above-described program is appropriately stored in the non-volatile storage device 95 at a shipment stage, an operation stage, or the like of the control device. Note that, in this case, as a method of supplying the above-described program, a method of installing the above-described program inside the control device by using an appropriate jig at a manufacturing stage before shipment, an operation stage, or the like may be adopted. Further, as the method of supplying the above-described program, a general procedure of a method of downloading from the outside via a communication line such as the Internet and the like may be adopted.

The whole or part of the example embodiments disclosed above can be described as, but not limited to, the following supplementary notes.

### Supplementary Note 1

A control device connected to
a base station, and
a reception device that is installed in a usage range being a range in which the base station can be used, and receives a user device signal being transmitted from a user device and including a device ID being identification (ID) of the user device, the control device including:
an acquisition unit that acquires, as a reception ID, the device ID included in the user device signal being received by the reception device in a case where the user device signal is received by the reception device; and
a control unit that controls a function associated in advance with the reception ID among functions of the base station.

### Supplementary Note 2

The control device according to supplementary note 1, wherein,
in a case where a function associated with the reception ID is a power function of the base station, the control unit performs control for turning on the power function of the base station in a state where the power function of the base station is off.

### Supplementary Note 3

The control device according to supplementary note 1, wherein,
in a case where a function associated with the reception ID is a power function of the base station and there are a plurality of the device IDs associated with the power function of the base station, in a case where none of the user device signal including the device ID associated with the power function of the base station is received by the reception device, the control unit performs control for turning off the power function of the base station.

### Supplementary Note 4

The control device according to supplementary note 1, wherein
the base station includes a plurality of components,
a part or a whole of the components is associated in advance with the reception ID, and,
in a case where there is the component that is not activated among the components associated with the reception ID, the control unit performs control for activating the component.

### Supplementary Note 5

The control device according to supplementary note 1, wherein
the base station includes a plurality of components,
a part or a whole of the components is associated in advance with the reception ID, and,
in a case where none of the user device signal including the device ID associated with the component is received by the reception device, the control unit performs control for stopping the component.

### Supplementary Note 6

The control device according to supplementary note 4 or 5, wherein
each of the plurality of components is mobile edge computing (MEC), a virtual user plane function (vUPF), or a virtual radio access network (vRAN).

### Supplementary Note 7

The control device according to supplementary note 1, wherein
a part or a whole of a plurality of network slices is associated in advance with the reception ID, and,
in a case where the network slice associated with the reception ID is not formed, the control unit performs control for forming the network slice.

### Supplementary Note 8

The control device according to supplementary note 1, wherein
a part or a whole of a plurality of network slices is associated in advance with the reception ID, and,
in a case where none of the user device signal including the device ID associated with the network slice is received by the reception device, the control unit performs control for setting a state where the network slice is not formed.

### Supplementary Note 9

The control device according to supplementary note 1, wherein
a plurality of the base stations are present, one or more of the base stations are associated with the reception ID, and
the control unit controls a function of the base station associated with the reception device that has received the user device signal including the reception ID among the base stations associated with the reception ID.

### Supplementary Note 10

The control device according to supplementary note 1, wherein
a plurality of the base stations are present,
one or more of the base stations are associated with the reception ID, and
the control unit controls a function of the base station associated with the reception ID.

### Supplementary Note 11

A control system including:
the control device according to any of supplementary notes 1 to 10;
the base station; and
the reception device.

### Supplementary Note 12

A control method of a control device connected to
a base station, and
a reception device that is installed in a usage range being a range in which the base station can be used, and receives a user device signal being transmitted from a user device and including a device ID being an ID of the user device, the control method including:
acquiring, as a reception ID, the device ID included in the user device signal being received by the reception device in a case where the user device signal is received by the reception device; and
controlling a function associated in advance with the reception ID among functions of the base station.

### Supplementary Note 13

The control method according to supplementary note 12, further including,
in a case where a function associated with the reception ID is a power function of the base station, performing control for turning on the power function of the base station in a state where the power function of the base station is off.

### Supplementary Note 14

The control method according to supplementary note 12, further including,
in a case where a function associated with the reception ID is a power function of the base station and there are a plurality of the device IDs associated with the power function of the base station, in a case where none of the user device signal including the device ID associated with the power function of the base station is received by the reception device, performing control for turning off the power function of the base station.

### Supplementary Note 15

The control method according to supplementary note 12, wherein
the base station includes a plurality of components, and
a part or a whole of the components is associated in advance with the reception ID,
the control method further including,
in a case where there is the component that is not activated among the components associated with the reception ID, performing control for activating the component.

### Supplementary Note 16

The control method according to supplementary note 12, wherein
the base station includes a plurality of components, and
a part or a whole of the components is associated in advance with the reception ID,
the control method further including,
in a case where none of the user device signal including the device ID associated with the component is received by the reception device, performing control for stopping the component.

### Supplementary Note 17

The control method according to supplementary note 15 or 16, wherein
each of the plurality of components is MEC, a vUPF, or a vRAN.

### Supplementary Note 18

The control method according to supplementary note 12, wherein
a part or a whole of a plurality of network slices is associated in advance with the reception ID,
the control method further including,
in a case where the network slice associated with the reception ID is not formed, performing control for forming the network slice.

### Supplementary Note 19

The control method according to supplementary note 12, wherein
a part or a whole of a plurality of network slices is associated in advance with the reception ID,
the control method further including,
in a case where none of the user device signal including the device ID associated with the network slice is received by the reception device, performing control for setting a state where the network slice is not formed.

### Supplementary Note 20

The control method according to supplementary note 12, wherein
a plurality of the base stations are present, and
one or more of the base stations are associated with the reception ID,
the control method further including
controlling a function of the base station associated with the reception device that has received the user device signal including the reception ID among the base stations associated with the reception ID.

### Supplementary Note 21

The control method according to supplementary note 12, wherein
a plurality of the base stations are present, and
one or more of the base stations are associated with the reception ID,
the control method further including
controlling a function of the base station associated with the reception ID.

### Supplementary Note 22

A non-transitory computer-readable recording medium recording a control program of a control device connected to
a base station, and
a reception device that is installed in a usage range being a range in which the base station can be used, and receives a user device signal being transmitted from a user device and including a device ID being an ID of the user device, the control program causing a computer to achieve:
an acquisition function of acquiring, as a reception ID, the device ID included in the user device signal being received by the reception device in a case where the user device signal is received by the reception device; and
a control function of controlling a function associated in advance with the reception ID among functions of the base station.

### Supplementary Note 23

The non-transitory computer-readable recording medium recording a control program according to supplementary note 22, wherein,
in a case where a function associated with the reception ID is a power function of the base station, the control function performs control for turning on the power function of the base station in a state where the power function of the base station is off.

### Supplementary Note 24

The non-transitory computer-readable recording medium recording a control program according to supplementary note 22, wherein,
in a case where a function associated with the reception ID is a power function of the base station and there are a plurality of the device IDs associated with the power function of the base station, in a case where none of the user device signal including the device ID associated with the power function of the base station is received by the reception device, the control function performs control for turning off the power function of the base station.

### Supplementary Note 25

The non-transitory computer-readable recording medium recording a control program according to supplementary note 22, wherein
the base station includes a plurality of components,
one function or a whole of the components is associated in advance with the reception ID, and,
in a case where there is the component that is not activated among the components associated with the reception ID, the control function performs control for activating the component.

### Supplementary Note 26

The non-transitory computer-readable recording medium recording a control program according to supplementary note 22, wherein
the base station includes a plurality of components,
one function or a whole of the components is associated in advance with the reception ID, and,
in a case where none of the user device signal including the device ID associated with the component is received by the reception device, the control function performs control for stopping the component.

### Supplementary Note 27

The non-transitory computer-readable recording medium recording a control program according to supplementary note 25 or 26, wherein
each of the plurality of components is MEC, a vUPF, or a vRAN.

### Supplementary Note 28

The non-transitory computer-readable recording medium recording a control program according to supplementary note 22, wherein
one function or a whole of a plurality of network slices is associated in advance with the reception ID, and,
in a case where the network slice associated with the reception ID is not formed, the control function performs control for forming the network slice.

### Supplementary Note 29

The non-transitory computer-readable recording medium recording a control program according to supplementary note 22, wherein
one function or a whole of a plurality of network slices is associated in advance with the reception ID, and,
in a case where none of the user device signal including the device ID associated with the network slice is received by the reception device, the control function performs control for setting a state where the network slice is not formed.

### Supplementary Note 30

The non-transitory computer-readable recording medium recording a control program according to supplementary note 22, wherein
a plurality of the base stations are present,
one or more of the base stations are associated with the reception ID, and
the control function controls a function of the base station associated with the reception device that has received the user device signal including the reception ID among the base stations associated with the reception ID.

### Supplementary Note 31

The non-transitory computer-readable recording medium recording a control program according to supplementary note 22, wherein
a plurality of the base stations are present,
one or more of the base stations are associated with the reception ID, and
the control function controls a function of the base station associated with the reception ID.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

1. A control device connected to
a base station, and
a reception device that is installed in a usage range being a range in which the base station can be used, and receives a user device signal being transmitted from a user device and including a device ID being identification (ID) of the user device, the control device comprising one or more memories storing instructions and one or more processors configured to execute the instructions to:
acquire, as a reception ID, the device ID included in the user device signal being received by the reception device in a case where the user device signal is received by the reception device; and
control a function associated in advance with the reception ID among functions of the base station.

2. The control device according to claim 1, wherein,
in a case where a function associated with the reception ID is a power function of the base station, the one or more processors are configured to execute the instructions to perform control for turning on the power function of the base station in a state where the power function of the base station is off.

3. The control device according to claim 1, wherein,
in a case where a function associated with the reception ID is a power function of the base station and there are a plurality of the device IDs associated with the power function of the base station, in a case where none of the user device signal including the device ID associated with the power function of the base station is received by the reception device, the one or more processors are configured to execute the instructions to perform control for turning off the power function of the base station.

4. The control device according to claim 1, wherein
the base station includes a plurality of components,
a part or a whole of the components is associated in advance with the reception ID, and,
in a case where there is the component that is not activated among the components associated with the reception ID, the one or more processors are configured to execute the instructions to perform control for activating the component.

5. The control device according to claim 1, wherein
the base station includes a plurality of components,
a part or a whole of the components is associated in advance with the reception ID, and,
in a case where none of the user device signal including the device ID associated with the component is received by the reception device, the one or more processors are configured to execute the instructions to perform control for stopping the component.

6. The control device according to claim 4, wherein
each of the plurality of components is mobile edge computing (MEC), a virtual user plane function (vUPF), or a virtual radio access network (vRAN).

7. The control device according to claim 1, wherein
a part or a whole of a plurality of network slices is associated in advance with the reception ID, and,
in a case where the network slice associated with the reception ID is not formed, the one or more processors are configured to execute the instructions to perform control for forming the network slice.

8. The control device according to claim 1, wherein
a part or a whole of a plurality of network slices is associated in advance with the reception ID, and,
in a case where none of the user device signal including the device ID associated with the network slice is received by the reception device, the one or more processors are configured to execute the instructions to perform control for setting a state where the network slice is not formed.

9. The control device according to claim 1, wherein
a plurality of the base stations are present,
one or more of the base stations are associated with the reception ID, and
the one or more processors are configured to execute the instructions to control a function of the base station associated with the reception device that has received the user device signal including the reception ID among the base stations associated with the reception ID.

10. The control device according to claim 1, wherein
a plurality of the base stations are present,
one or more of the base stations are associated with the reception ID, and
the one or more processors are configured to execute the instructions to control a function of the base station associated with the reception ID.

11. A control method of a control device connected to
a base station, and
a reception device that is installed in a usage range being a range in which the base station can be used, and receives a user device signal being transmitted from a user device and including a device ID being an ID of the user device, the control method comprising:
acquiring, as a reception ID, the device ID included in the user device signal being received by the reception device in a case where the user device signal is received by the reception device; and
controlling a function associated in advance with the reception ID among functions of the base station.

12. A non-transitory computer-readable recording medium recording a control program of a control device connected to
a base station, and
a reception device that is installed in a usage range being a range in which the base station can be used, and receives a user device signal being transmitted from a user device and including a device ID being an ID of the user device, the control program causing a computer to achieve:
an acquisition function of acquiring, as a reception ID, the device ID included in the user device signal being received by the reception device in a case where the user device signal is received by the reception device; and
a control function of controlling a function associated in advance with the reception ID among functions of the base station.
